(19) United States
(12) Patent Application Publication
(10) Pub. No.: US 2005/0006152 A1
(43) Pub. Date: Jan. 13, 2005

(54) Weighntel

(76) Inventor: Subhi K. Eldeiry, E Greenbush Rensselaer, NY (US)

Correspondence Address: Dr. Subhi Eldeiry, 15 Brook Street, Rensselaer, NY, 12144-4255, US

(21) Appl. No.: 10/613,153

(22) Filed: Jul. 7, 2003

(51) Int. Cl. G01G 19/22

(52) U.S. Cl. 177/25.11

(57) ABSTRACT

WEIGHNTEL is a weighing device, a scale that is capable of automatic instantaneous wireless transmission of recorded weights that are packaged or associated with other data as identification, date, and time. This is wireless transmission of a recorded weight and other business related data, of objects including living beings, to any location on earth or in outer space. Using existing technology a scale can be manufactured to accomplish electronic transmission of weights after recording them with account ID, date and time on a computer disc. Digital scales may be used and preferred over other traditional scales. Objects to be weighed vary from tiny objects such as jewelry, postal items, to human beings, pets and animals, cargo in seaports, airports, and rail stations or to be loaded on commercial or military trucks or other transportation vehicles. Weighing cargo in this innovative manner can help to safeguard against illegal interventions over time or space. Weighing human beings can help to generate a more accurate and meaningful weight record, or weight history from birth to end of life, or from any point of beginning to termination of the account. Adding a global locator feature could be of unimaginable security value especially if the devices are globally marketed. Adding a camera or video camera would perhaps be a luxury that increases the cost of production but also enhances security. Adding sensors such as a scanning device can help to pick a unit ID and include it with data to be transferred. The device could be programmed to make automatic corrections to weights that are influenced by geography in locations that alter the gravity effect. [e.g. a weight on earth is 6 times that on the moon]. Either the transmitter and receiver ends can be portable mobile or they can be stationary i.e. a scale can be small and portable or huge and fixed to a location. A receiver can be a portable hand held device, a telephone or a stationary computer or a laptop. Transmission is basically performed by an electronic transmission device in a manner similar to TCP/IP packet transmission or email transmission between two ends or computers. Wireless data transmission happens from scale to a location on the Internet, Intranet or any receiver device and vice versa using end to end wireless data transmission protocol. Every transmitting device within a scale is programmed for a specific goal that is defined by the type of business involved. Every receiver device and each software program is built for a specific goal that is defined by the type of business involved. At the receiver end transmitted data are automatically entered into the account ID file. Data are further processed to produce a graph or a table or both showing the details of the transaction and relation to prior transactions. A printable file shows weight progress from the date of subscription to the account to the date of the last transaction. With each transaction a new updated file is produced without deleting previous records.

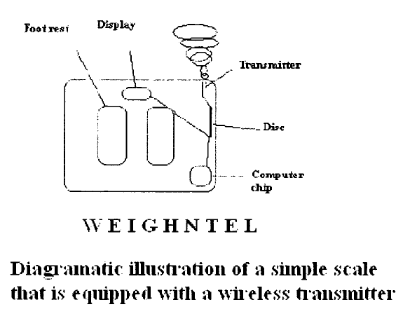

### BACKGROUND OF INVENTION

As a retired physician of nearly half a century of experience who is self educated in some computer knowledge I wanted to innovate for health particularly relative to overweight and obesity. This is one innovation that connects health sciences and commerce with both the computer and Internet ages. The goal in the long term is to serve both health and commerce at the national as well as the global levels. Charging pennies for weight wireless transmission transaction would quickly transform the idea to unlimited education, advertising and other indirect potentials. Affordable global reaches for wireless weight recording and transmission and electronic payments will have a long-term impact on health, commerce and security. The use of prepayment for semiannual, annual or more transactions can be achieved easily in this electronic age. It can be done through appropriate bank accounts, credit card accounts or even coin operated machines.

With global economy evolving and progressing weight recording using WEIGHNTEL model system of merchandise before and after import and export or inland transportation is perceived as a major improvement over current procedures. In the case weighing human beings periodically for health the United States will be a leader in an initiative that spreads globally. One possible important social outcome is that it connects and brings people closer globally speaking over the important subjects related to weighing in relation to health and in relation to international commerce.

Meaningful Weight Recording and Monitoring:

Recording weights is already in use for many millennia whether for everyday consumer items, for science and research or for monitoring living beings or various agricultural or industrial products. The computer age and the Internet age and e-commerce have opened unlimited innovations that keep expanding. Keeping electronic weighed data or records and wireless transmission of weighed data or records is a good innovative common sense idea. It provides opportunity for confirmation of weights that belong to a specifically identified account at departure and destination points not only to local officials but at the central corporate or government levels as well. It also provides an instant detection of weight changes that provoke suspicion. This idea is so simple and sensible that it is not so readily obvious. Attempts by the author to write a book on innovative weight control over the past two decades provoked thinking about this among other innovative ideas.

Commercial Uses:

Upgrading of existing equipment, procedures and services may not be feasible or economic for small scales, but could be considered for large scales e.g. scales designed to weigh trucks or heavy weight shipping. The addition of the computer chip, software and transmission devices should not be difficult or costly.
New procedures and services. Individuals, companies and other organizations and government entities that evaluate this invention will find innovative ways to improve products and services or start new ones. Shipping procedure for going out of the country or receiving in the country will be modified or new procedures started to achieve optimum production and distribution of goods and services. Airlines will find ways of improving services and security. In health care the tremendous advantages seen by the inventor who is an experienced retired physician may only become clear over time.

### WEIGHNTEL

Prior Art:

Although wireless transmission is already in use for different purposes, no method of wireless weight transmission and no business plan that is analogous to the above-mentioned claims was found upon searching patents within a period slightly exceeding two decades.

### PREFERRED EMBODIMENTS OF INVENTION

Human health: It goes without saying that unhealthy human weights contribute to many often-serious health problems. Clinical weight monitoring is a crucial part of weight history that could be significantly improved if it is standardized for birth to death monitoring with reliable weighing and recording methods [or from a starting date to end of life]. This invention provides a method that could prove to be very useful in this respect. If we examine several patient or healthy client records we are likely to see inconsistency and irregularities in weight history and weight records. This invention allows a clear display of an accurate record complete with graphs and updates. Using pennies to achieve a goal like that will certainly pay in terms of awareness by customers and health care providers alike. Periodic awareness of potential health problems observed by clients and preventive and restorative health care providers may prove to be extremely valuable over time. Having a graph showing a client's weight record or a patient's weight record can be very useful in many different ways of health education, research and innovation. Many fitness and weight control centers as well as individuals would probably significantly benefit from this innovation.
Animal health: Agricultural private or government entities that care about weighing their products may benefit from this method because it helps quality control, accounting and legal control.
Agricultural productions: Agricultural harvests, as well as agricultural industrial products can use this method for quality control and statistical purposes.
Industrial productions: Major industrial plant outlets may find it beneficial to monitor product consistency and shipping using this method.
Wholesale outlets: Weighing goods before shipping at outlets and at receiving stores could prove to be very useful for quality control as well as for legal control.
Transportation: Weighing trucks or other carriers on the highways, or rail cars or any shipping or transportation vehicle for various purposes will never be the same by using this method!
Retail stores: It is not inconceivable that a time might come to help customer satisfaction by monitoring retail weights for quality and legal control.
Research private and government, universities, statistics, media: Data that are generated from wireless weight transmission could be instantly translated into extremely valuable statistics whether for commerce or for human health or otherwise. Universities and research institutions could see new methods of utilization of generated data or statistics or at least compare them to traditional methods.

### BRIEF DESCRIPTION OF DRAWINGS [attached file name: weighdiagram.doc]

A simple diagram illustrates the wireless transmitter being incorporated inside an ordinary scale. It goes without saying that varied devices and software that is specifically programmed for the business can be installed inside any new small or large scale whether custom built or otherwise.

Special Detailed Notes

Clinical Weight Monitoring:

Principle: To create in graphs and tables a reliable weight history from birth to death or from starting date to end of subscription, to be incorporated in medical records or to be available for other uses such as research or statistics. This requires continuous periodic updating of records to include changes in weight as they happen from the beginning to the end of life. This will be proven to be the most important principal use of the invention.

Importance: There is no doubt that overweight and obesity as well as underweight have the potential to cause severe health problems that can result in disability or death. It is the duty of every physician to record and follow the weight of his patients. WEIGHNTEL is a method for providing physicians and other health care providers with accurate updated weight record. This is going to have a positive impact on health care in general but particularly on preventive care. It is going to assist government and private authorities in both national and global continuous assessment of this epidemic. It is going to improve awareness among individuals and care providers on a continuous basis about weight and weight related problems.

Possible Recommendation:

Every medical record, every health record for health or unhealthy people, every weight record for fitness or any other purpose should include updated data through WEIGHNTEL or other licensed systems. For the newborn using the method of WEIGHNTEL provides a great opportunity to have an accurate birth to death weight record. For adults that begin using the method of WEIGHNTEL a less accurate but still very useful birth to death record can be obtained. Taking a history plus obtaining possible weight records from pediatricians, primary care physicians, schools, the military, jobs or any possible source can help to fill the gap that was missed before subscribing to the method of WEIGHNTEL. It should be clear that for human weight accurate history periodic weighing is herein recommended to be weekly. This will translate in a nearly uninterrupted continuous record during the life of this human being. For bed-confined or disabled individuals weight records may be even more important. In these circumstances the weighing devices have to be manufactured to suit for each situation. One possibility would be to design a hospital bed with weighing device with WEIGHNTEL method. It goes without saying that this requires special manufacturing design and special software to run the program. For disabled individuals that are bed-confined at home or in nursing homes, the benefits of weekly weighing would be extremely helpful to their physicians.

Use in Seaports, Airports, Truck Ports and Train Loading Stations:

Monitoring weights of objects before, during, and after transporting them is a wise sensible policy. Incorporating laser scanners, cameras or video cameras, X-ray or other detection devices e.g. Geiger counters to detect radioactivity might enhance security. The instant wireless data transmission can greatly save time and money as it can minimize manual work. Let us mention just one possible scenario for airport weighing procedures that might contribute to enhancing security. A weighing and detection station outside the airport security zone. An individual or a family is required to weigh himself; family and baggage using his pre-purchased electronic ticket or ticket number for id. The airline and security computers pick this transaction through wireless transmission. Another confirmatory transaction for the same ids is done at a suitable location inside the airport e.g. at security check or at the counter. Two or more confirmations as feasible can theoretically be done by placing weighing stops during automatic baggage transfer and at the boarding destination, even inside the plane's cargo bay. The likelihood of baggage exchange or smuggling anything inside the baggage will be enormously reduced particularly if each baggage unit id is scanned as well. The computer program would detect any significant change in weight and an alarm is sounded. Of course this does not prevent the use of metal detectors along the way.

Both the stores' computer and that of security factor in items purchased from inside of the airport if allowed. Although this scenario cannot be 100% proof it possibly contributes to minimizing hand searches and delays. Slots inside the cargo bay of airplanes could be equipped with scales that confirm both ticket ids unit ids and weight consistency.

In the case of weighing cargo before loading on trucks, ships, rail cars or cargo planes a similar scenario can be constructed. Each individual cargo box or package will have a scanable account id number as well as a unit id. Each weighing transaction is wirelessly transmitted before loading and at every weighing post along the way until a final wireless transaction is done upon delivery. This is simply stated a process of association of pickup and delivery and anywhere possibie between pickup and delivery with data wireless transmission. Even in space travel continuous monitoring of weights, ids, date and time of each individual and each weighable unit on board can be very helpful.

Benefits:

Utilization of both Internet and wireless technologies is sure to modernize weighing businesses Job creation and stimulation of a good portion of national and global economies.
A more meaningful approach to human weight recording that influences health and health care in general and weight related health problems in particular. The use of this model system in schools and in the military would provide a practical role model education for the entire society.
Better quality control for businesses that use WEIGHNTEL scales
Better security control for businesses that use WEIGHNTEL scales
Better legal control for businesses that use WEIGHNTEL scales
A potential for stimulation and advancement of other businesses that are not involved in weighing as advertising, education, research and media.

1. “WEIGHNTEL” is a method of wireless transmission of bundled or packaged data from a scale to another location using a software program depending on the specific business. The data include the recorded weight, date, time, name and account identification number (ID) and unit ID when applicable of objects including living beings.
Produced in many different sizes and shapes depending on the business, the scale functions as a wireless data transmission scale capable of:
Digital display of the weight of objects ranging from the smallest with smaller scales to the largest possible size with larger scales. Objects including living beings may be weighed in units or groups for many different purposes. For each category there will obviously be a need to produce scales of specific size and capacity. For weighing living beings health and safety considerations will need to be observed.
Capturing, or recording and storing each separate transaction in a secure file that has the identification data of the weighed object. The file is inside a computer disc inside the scale.
Automatic wireless data transmission optionally including pictures recorded by camera or video camera or scanned account and unit id when applicable, to an intranet, web site on the Internet such as weighntel.com or any authorized licensed receiver device. Secure wireless transmission of data includes ID data, date, time, and recorded weight, and including pictures recorded by camera or video camera when applicable. American and or international measuring systems or both may be used to record weights plus any other data that can be pre-programmed to serve an additional purpose for the specific business.
To achieve automatic wireless data transmission a computer or computer chip with software program is connected with the wireless transmission device inside the scale. When an object is weighed the program picks the value of the weight and bundles it with the account ID, unit ID if applicable, dates and time and forwards the file or “packet” to the wireless transmission device. This in turn sends the secure file or packet to the receiving end on the intranet, Internet or on another device such as a telephone.
Definitions:
Account ID refers to an identification number or a code of a registered account
Unit ID refers to an identification number or a code of a unit of the object to be weighed. According to this definition a human being is a unit when being weighed where the account ID may be the same as unit ID. A box of goods ready to be shipped in some port is a unit within a given account. It is clear that many similar or different units can belong to one account ID but each will have its distinctive ID. An incorporated scanning device placed in a suitable location picks both account ID and unit ID. The whole idea of a unit ID is extra, extra security If there is a serial number it could be used as a unit ID.

2. A method according to claim # 1 of software programs designed to be specific for data transmission from a given scale to a pre-programmed target location e.g. weighntel.com. A WEIGHNTEL software program in general will allow the following:
a. The capability of storing encrypted data safely in both ends that are to be connected for the wireless transmission.
b. The capability of registering new accounts and freezing or terminating accounts depending on the specific business plan involved
c. The capability of receiving data from each registered account and keeping a log of all transactions within each account including date and time of transaction. This means the capability of identifying registered accounts and rejecting non-registered entries.
d. The capability of depositing received funds in a bank account and or returning them when electronic accounts are used
e. The capability of creating graphs and tables reflecting received weight data and entering them into each individual account file that has the constant ID data. Updated files do not cancel or replace prior records.
f. The capability of transmitting encrypted files to physicians, clients, and authorized private or government agencies requesting them for business. This means the added capability of verifying the identity of the requesting source. This function is performed on demand either one time demand or periodic demand by prearranged contract.
g. The capability of retrieving or tracking transactions by ID, date, time and other data for use on demand by authorized individuals or organizations.
h. The capability of sounding an alarm or sending an alert signal when a record of weights is outside a certain expected range e.g. previous weight recorded plus or minus 5%. This 10% range is arbitrary because it has to be decided by the specific business or the specific situation. To further clarify this point a human being that was weighed a week ago could have the acceptable range of weight increase or decrease within 7 days determined by the personal physician or by experts helping the business then incorporated in the program.
These functions are included in a software program that is designed to suit the particular business to use it A scale for weighing human beings can be produced to suit one of the following categories:
a. Personal WEIGHNTEL: Only one owner would use a programmed scale for weighing himself or herself. The program would lock the ID number of the personal account so that no one else can use it for wireless transmission. A well-built scale for this purpose would be expected to provide consistency with less likelihood of errors and is the ideal model for a successful business. Such a model may not be suitable for use from birth to death but can be used for adults after being programmed to follow on custom produced pediatric scales.
b. Family WEIGHNTEL would be designed to serve one family with one account but multiple unit ids, and could be reprogrammed to include new additions to the family as feasible. This category excludes pediatric scales.
c. Public WEIGHNTEL: Subscribers that could not or forgot to carry the personal scale during travel would use the public scale that is separate or attached to vending machines or other secure posts. It also serves for subscribers that do not wish to purchase a personal or family scale or could not afford it. Such public scales could be commercially feasible but would need to be durable enough to stand heavy duty weighing. Also it would need more meticulous security safeguards to protect from theft, vandalism and computer hacking.
d. Pediatric WEIGHNTEL scales could be produced as ordinary pediatrician's scales only equipped with WEIGHNTEL. The software with its collective capabilities and functions that serve a specific business are claim # 2

3. A method of a general business plan according to claims 1 & 2:
A Corporation is started using the name WEIGHNTEL and or weighntel.com. Under certain circumstances a large corporation could buy the invention and introduce modifications or names to suit. (weighntel.com is a domain that is owned by the inventor.)
The initial startup fund would not be significant and can be borrowed
A production plan would be based on two phases:
1—Outsourcing for scales and for the business specific software
2—Building a plant to produce the smart WEIGHNTEL scales
Operational details would be decided by the corporation's board based on:
1. Selling or leasing scales and or associated services to individuals, corporations and interested government or private entities
2. Demonstrating the business to customers and to the media when the occasion is appropriate
3. Running one or more web sites to receive data, process them and store them safely
4. Charging for wireless transactions using a method that depends on the specific business. One scenario for weighing human individual clients that own a personal WEIGHNTEL and want to monitor their weights could be constructed as follows: A client subscribes to the service for a monthly or annual fee. In addition the client pre-pays say $ 10.00 or 25.00 renewable [Example $ 0.50 for each weekly transaction of weight transmission from the scale to the subscriber's account]. After each or several transactions a record of weekly weights can be produced on demand by the corporation and sold for a nominal fee to the client or his personal physician or health care provider [say $ 3.00 for each requested report]. The record may include a graph that clearly shows the progress of the weight over time. Similar scenarios can be constructed for just about any business that is involved in weighing or in required weighing of any object or objects. Global expansion of the business with affordable fees would be expected to build up quickly and generate priceless data for health care professionals or other businesses worldwide.
5. Selling the data to clients, health care providers, media, import and export corporations, transportation companies, government and private research entities, universities, or any interested business. Demand is expected to be great because of the time and money saving capabilities and security enhancement.
6. Quality control and legal control
7. Accounting and budget control
8. Statistics to be used for quality control and for sale to interested customers.
Innovation and research.
This brief business plan outlines only the essential features required to broadly use the invention, but can and probably would be modified to suit any specific business or situation. The general business plan is claim # 3
